(19) United States
(12) Patent Application Publication
(10) Pub. No.: US 2013/0281776 A1
(43) Pub. Date: Oct. 24, 2013

(54) Sexual Stimulation Devices and Methods

(71) Applicant: Tricatalyst, LLC, Berkeley, CA (US)

(72) Inventor: David H. Levy, Berkeley, CA (US)

(21) Appl. No.: 13/839,404

(22) Filed: Mar. 15, 2013

Related U.S. Application Data
(63) Continuation-in-part of application No. 12/539,529, filed on Aug. 11, 2009.
(60) Provisional application No. 61/087,821, filed on Aug. 11, 2008.

(51) Int. Cl. A61H 23/02; A61H 19/00

(52) U.S. Cl. CPC A61H 23/02; A61H 19/44
USPC 600/38; 601/82

(57) ABSTRACT

A sexual stimulation device has a housing and an exposed sexual organ contact surface supported by the housing. The housing defines an elongated internal cavity having a longitudinal axis extending away from the contact surface. The device also includes a mass laterally constrained within and movable linearly along the cavity, and an electrically driven actuator disposed within the housing and operable to accelerate the mass along the axis of the cavity, thereby oscillating the contact surface in a linear motion along the longitudinal axis.

### CROSS-REFERENCE TO RELATED APPLICATIONS

This application is a continuation-in-part of co-pending U.S. application Ser. No. 12/539,529 (Sexual Stimulation Devices and Methods) filed Aug. 11, 2009, which claims the benefit of U.S. provisional application Ser. No. 61/087,821 (Sexual Stimulation Devices and Methods) filed Aug. 11, 2008, the entire disclosures of both of which are incorporated herein by reference.

### TECHNICAL FIELD

This invention relates to devices and methods to sexually stimulate the human body.

### BACKGROUND

Vendors today manufacture vibrators with a small mass (typically under 5 grams), with high frequency (typically 200 to 1000 RPM) and with the mass located off-center on a rotary motor. These devices are characterized by providing non-motile vibration. While popular, one of the known limitations of these products is that high frequency vibration can desensitize the sexual response, thereby making non-vibratory sexual relations more difficult. There are also phallus-shaped devices that provide very low frequency, high amplitude thrusting motions designed to mimic the sexual act without necessitating motion of the base. Such devices can be “stand-alone” (i.e., with one end immovably constrained) or hand held. Both seek to mimic the thrusting motions of intercourse.

### SUMMARY

One aspect of the invention features a sexual stimulation device with a housing and an exposed sexual organ contact surface supported by the housing. The housing defines an elongated internal cavity having a longitudinal axis extending away from the contact surface, and a mass is laterally constrained within and movable linearly along the cavity. An electrically driven actuator is disposed within the housing and operable to accelerate the mass along the axis of the cavity, thereby oscillating the contact surface in a linear motion along the longitudinal axis.

In some embodiments the actuator includes a coil of wire axially aligned with the cavity. The actuator may comprise an electromechanical solenoid having an armature disposed within the coil of wire. In some examples the armature is mechanically coupled to the contact surface. In some cases the armature is magnetically coupled to the contact surface

In some embodiments the actuator has first and second magnets arranged such that repellant force between the first and second magnets applies a motive force to the contact surface.

In some examples the device includes a magnet operably coupled with the contact surface.

For some applications, the contact surface is substantially flat.

Some examples of the device have a controller coupled to the actuator and configured to control motion induced by the actuator. In some cases, the controller is configured to control motion of the contact surface according to a preset motion profile. The motion profile may include a first acceleration rate in a first direction along the longitudinal axis, for example, and a second acceleration rate in a second direction along the longitudinal axis, the second acceleration rate differing from the first acceleration rate.

Preferably, the actuator is operable to produce a displacement of the contact surface of at least 10 mm (even more preferably for some applications, at least 20 mm) along the longitudinal axis.

In some embodiments, the actuator is a linear motor.

In some cases the device is phallic-shaped.

The cavity may be fully enclosed within the device, for some applications.

According to another aspect of the invention, a sexual stimulation device has a housing and an exposed sexual organ contact surface supported by the housing. The contact surface is arranged to remain outside of human body and in contact with a sexual organ during use. An electrically driven actuator disposed within the housing is operable to induce a linear oscillation of the contact surface normal to the sexual organ.

In some examples the actuator includes a linear actuator, which may have a coil of wire disposed about a longitudinal cavity defined within the actuator.

In some embodiments the actuator has a linearly displaceable armature carrying a first magnet, and the device also includes a second magnet attached to the contact surface and configured to be repelled by the first magnet. The armature may comprise a non-ferromagnetic material.

According to another aspect of the invention, a sexual stimulation device includes a housing and an exposed sexual organ contact surface supported by the housing and adapted to contact a sexual organ of a human body while remaining outside the body. An electrically driven actuator is disposed within the housing and operable to oscillate the contact surface in a linear motion in which the contact surface is displaced, with respect to the housing, along an axis perpendicular to the contact surface.

In some embodiments the actuator includes a first magnet moved by operation of the actuator, and the device has a second magnet mechanically coupled with the contact surface. The first and second magnets are configured and positioned such that motion of the first magnet induces a motion of the second magnet and the contact surface. In some cases the first and second magnets are configured such that in their nearest positions similar poles of each magnet are facing one another, such that the first magnet repels the second magnet. The first magnet may be configured to be moved by operation of the actuator along a linear, reciprocating path, or along a circular path. In some examples the actuator includes multiple magnets spaced about a perimeter of an armature, such that rotation of the armature brings each of the multiple magnets in succession into proximity with the second magnet. Adjacent ones of the multiple magnets may be of opposite polarity arrangement, such that rotation of the armature alternately repels and attracts the second magnet.

Some embodiments have a spring coupling the contact surface and housing, with the actuator configured to oscillate the contact surface at a frequency selected to correspond with the natural frequency of the contact surface in association with the spring.

In some embodiments the housing defines an elongated internal cavity having a longitudinal axis substantially perpendicular to the contact surface. The actuator may include a coil of wire disposed around the cavity. In some cases the actuator comprises an electromechanical solenoid having an armature disposed within the coil of wire. The armature may be mechanically or magnetically coupled to the contact surface.

In some embodiments the contact surface has an exposed elastomeric material positioned to contact the sexual organ.

For some applications the contact surface is generally cylindrical and configured to fit about a male sexual organ. For some other applications the contact surface is substantially flat.

Some examples of the device have a controller coupled to the actuator and configured to control motion induced by the actuator. In some cases, the controller is configured to control motion of the contact surface according to a preset motion profile. The motion profile may include a first acceleration rate in a first direction along the perpendicular axis, for example, and a second acceleration rate in a second direction along the perpendicular axis, the second acceleration rate differing from the first acceleration rate.

Preferably, the actuator is operable to produce a displacement of the contact surface of at least 10 mm along the perpendicular axis, or in some cases at least 20 mm along the perpendicular axis.

Another aspect of the invention features a method of creating sexual stimulation, the method includes bringing the contact surface of one of the above-described devices into contact with a sexual organ, and holding the device with the contact surface in contact with the sexual organ while the actuator is operated to oscillate the contact surface in a primarily linear motion along the longitudinal axis.

Embodiments of this invention may be advantageously configured to provide a stimulation that may be different from the thrusting motion of intercourse and yet not as desensitizing to the sexual organs as some known devices and methods. This different stimulation may be oscillatory, but with a frequency lower than provided by typical rotary vibrators with an off-center mass. Some examples may be capable of providing stimuli that are varied, controllable, and subtle. The variable sensation may be independent of any thrusting motion imposed on the device by the hand of the user, and the variable sensation may be dependent on the thrusting motion in a variety of predictable and semi-predictable and non-predictable ways. The sensation may be dynamically variable, or under dynamic control, whether the user is co-located, or distant.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a sectional view of a dildo with a linear vibration, large masses and linear actuators.

FIG. 2 is a generic embodiment of FIG. 1.

FIG. 3a is an axial sectional view of a sexual stimulation device incorporating magnets.

FIG. 3b shows a magnet of FIG. 3a in a first state.

FIG. 3c shows a magnet of FIG. 3a in a second state.

FIG. 4a is an axial sectional view of a sexual stimulation device with alternate magnet-repelling means.

FIG. 4b shows one solenoid of FIG. 4a in a first state.

FIG. 4c shows one solenoid of FIG. 4a in a second state.

FIG. 5a is an axial sectional view of a sexual stimulation device with independently operable solenoids.

FIG. 5b shows one solenoid of FIG. 5a in a first state.

FIG. 5c shows one solednoid of FIG. 5a in a second state.

FIGS. 6-8 show additional arrangements for controllably applying pressure and/or motion to a segment of a surface.

FIG. 9 schematically illustrates another sexual pleasure device. Like reference symbols in the drawings indicate like elements.

### DETAILED DESCRIPTION

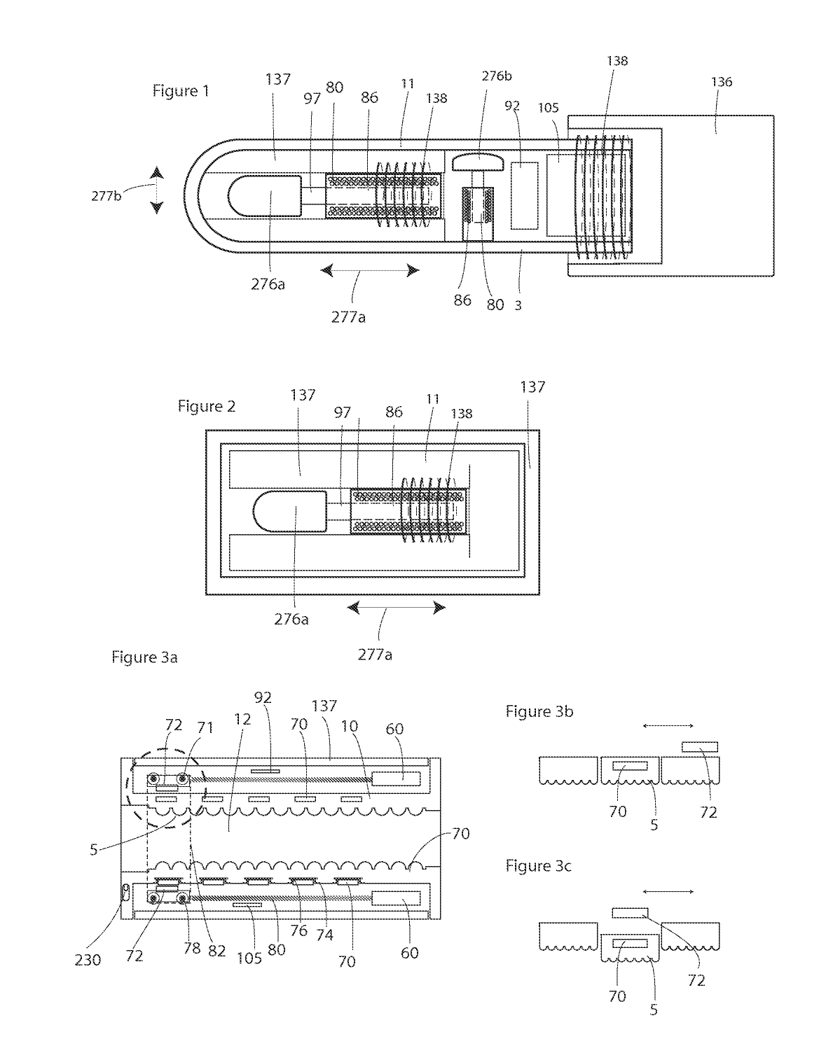

FIG. 1 shows a sexual pleasure device 3 with a linear displacement actuator 80 oriented radially, and accelerating a mass 276b and a second linear displacement actuator 80 oriented axially, and accelerating a mass 276a within the internal housing 137 of the device. The weight of each of the accelerated masses 276a and 276b (calculated separately along each axis) is selected according the desired performance dictated by MV=mv where:

m=mass of the accelerated mass (276a or 276b)

v=the velocity imposed upon the accelerated mass by its displacement actuator

M=the mass of the device, less the accelerated mass

V=the velocity of the device as it physically displaces along the axis of motion.

Compared to some known sexual stimulation products containing accelerated masses, in this device the accelerated mass is substantially increased, the frequency is substantially decreased, the motion of the mass is linear, and the mass drive mechanism is internal to the device. The objective is to provide a sensation that is not vibratory, but rather a physical displacement of the device that is superimposed on the self-directed hand motion. Unlike the prior art, this embodiment is capable of a single oscillation cycle providing a significant sensation to a user, because a measurable degree of motion and hence friction is felt, as opposed to merely non-motile vibration. This additional motion may be along the major axis, as provided by mass 276a and its associated linear displacement actuator 80 (providing a displacement force along axis 277a), or may be along the a radial axis, as provided by mass 276b and its associated linear displacement actuator 80, providing a displacement force along axis 277b. Linear displacement actuators 80 include two types: the first is electromechanical solenoid 86, typically a metal rod or metal core 97 within a coil of wire (often with a return spring) typically used for transient force application with a low degree of control. In one embodiment, the diameter of the metal core 97 is in the range from 1.5 mm to 10 mm. Field strength in a solenoid is independent of diameter. Therefore a benefit of small diameter metal cores 97 is to reduce the amount of conductor (typically copper) needed to manufacture the associated solenoid. The second type of linear actuator 80 is a linear motor 87, typically a magnet (or magnets) placed within a magnetic field and typically used for higher degrees of control. Creating motion of a magnet by flowing electrical current through a wire and using induction to move a rod within a solenoid is disclosed in high school physics texts. Masses 276a and 276b may be made from any dense material such as steel, lead or tungsten. In one embodiment, each mass 276a (or 276b) and its associated linear displacement actuator 80 are separate elements. In the preferred embodiment the cross section of mass 276a and 276b is round, but other cross-sections are envisioned.

The housing of the device may include an elastomeric sheath over an internal housing 137. The user's hand may be shielded from the motions of the device through an isolation mechanism 44 located between handle 136 and internal housing 137 or shaft 155. Isolation mechanism 44 may include a spring element 138 or a sliding mechanism, (such as a protruding wall in a groove or a flexure) that allows low friction linear motion between the shaft 155 and the handle 136.

In one embodiment the displacement of mass 276a or mass 276b is at least 10 mm. In another embodiment, displacement of mass 276a or 276b is at least 20 mm. The amplitude and acceleration curves may be varied, as well as the frequency, thereby enabling a wide range of sensations to the user. For example, one embodiment provides multiple sequential stimuli in a single direction. A specific example of this embodiment is overall travel distance (X) of a linear displacement actuator 80 of 27 mm in which the device provides three sequential and discrete movements (i.e. “thumps”) of approximately 9 mm each, all in a first direction without recoiling. In one embodiment the controller 92 initiates a plurality of such sequential unidirectional discrete motions in a relatively short time, thereby providing a distinctly different sensation than simple oscillation. In one embodiment the device traverses the two longitudinal directions (i.e., in and out or plus and minus) at distinctly different rates, moving in a first direction at a high rate of speed/acceleration, thereby noticeably displacing the device (and providing the associated sensation of displacement) and subsequently returning in the opposite direction at a significantly slower rate such that the recoil and the associated motion of the device 3 is substantially smaller, if detected at all. This pattern may be repeated, thereby providing the sensation that the device is only thrusting in a single direction. By modifying the acceleration curves, displacements and sequences in this manner, a wide range of novel sensations may be provided. In one embodiment controller 92 includes input from a wireless transceiver such as Bluetooth or Wi-Fi disposed within dildo 3, thereby enabling communication to the Internet and cellular communications.

FIG. 3a shows an embodiment in which magnets 70, disposed on or near the outer surface of sleeve 10, are used to apply pressure along contact surface 5 to a sex organ located within sleeve 10, itself located within housing 137 made of a rigid material such as ABS. Magnets 70 may be co-molded within sleeve 10, as shown in the upper half of the figure, or adhered, as shown in the lower half of the figure. If adhered, it is desirable to use a carrier interface 74, preferably molded from a plastic, to both distribute the force of the magnet and to allow an intermediate bonding surface, i.e., magnet to plastic and plastic to sleeve 10. Carrier interface 74 also includes flange 76 to provide mechanical bonding. In one embodiment sensations are provided to a user by at least one drive magnet 72 brought into proximity to each fixed magnet 70 sequentially. Controls 92 may be implemented with discrete electronics to drive a shuttle 78 axially (as shown) by threaded shaft 80 driven by motor 60. Shuttle 78 may have sliding engagement with housing or wheels 71. Alternate drive mechanisms, such a belt drive, are also envisioned. The objective is to displace a local region of contact surface 5 by displacing a magnet 70 that is positioned to be operably associated with that specific local region. Magnets 72 and 70 are oriented with like poles facing each other in order to repel one another.

In this embodiment ring 82 holds a plurality of drive magnets 72 disposed about the circumference of sleeve 10, such that operation of motor 60 displaces the shuttle and provides a constricting sensation by simultaneously repelling the magnets 70 disposed within the ring inward. Ring 82 may be driven by a single motor 60 concentric with the sleeve, or by several smaller motors distributed about the sleeve. As the ring 82 moves back and forth, regions of contact surface 5 (along the ring) are simultaneously displaced inwardly toward each other.

Each magnet 70 is associated with a local contact surface 5. FIG. 3b shows a first state in which drive magnet 72 is distant from a magnet 70 and contact surface 5 is in a first position. FIG. 3c shows a second state in which drive magnet 72 has been translated from a distant location to close proximity with local contact surface 5 and its associated magnet 70. As the two magnets are brought closer together, increasing repellent force is placed on contact surface 5. Contact surface 5 is displaced inward, away from drive magnet 72, causing contact surface 5 to apply pressure to a sexual organ. Sleeve 10 is manufactured of low durometer elastomeric material, such as styrene-ethylene propylene-styrene block copolymer (SEPS) or any material that approximates human flesh. The contact surface 5 of cavity 12 may be smooth or have a texture as shown.

Approximating the human male sex organ as an idealized cylinder is an engineering approximation. The cavity 12 may be tapered, or have molded undulations, or irregularities and the like, as desired to provide stimulation to the human body (i.e., by inducing relative changes in force and/or pressure).

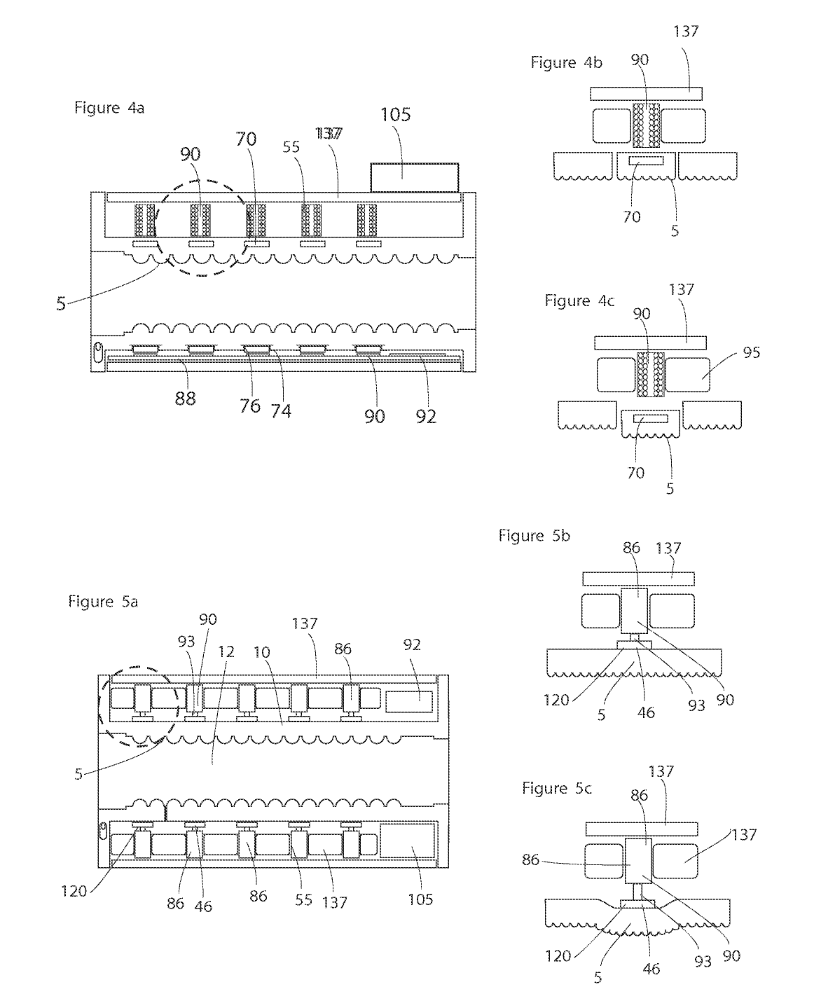

FIG. 4a shows an example with a similar magnet sleeve as described in FIG. 3a, but in which actuation is provided by means of a series of inductive coils 90, alternatively illustrated as inductors within solenoids 86 in the upper half of the figure, or as printed within a printed circuit board 88 as shown on the lower half of the figure. Coils 90 are in electrical communication with a control system 92 and a power source 105 such that one or more magnets 70 may be displaced individually or in sets to provide a wide variety of sensory outputs to a sexual organ located within sleeve 10 or otherwise in contact with contact surface 5. This embodiment allows for the actuation of individual (i.e. specific) locations, as opposed to rings or lines, or relatively large areas, and may provide differing frequencies of stimulation at each coil 90. For example, while all actuators may provide a constant force (i.e. pure contracture), rhythmically altering force, or a force altering in sequence of waves along sleeve 10, one or more coils 90 may provide a low or high frequency localized vibration, which may remain in one location or may be superimposed onto the aforementioned output. The system may provide random (or pseudo-random) output, thereby inducing a massaging/tingling sensation to the body part over a range of frequencies, from very low (e.g., near zero) to very high (e.g., 100 Hz). Each coil 90 is held by a chamber 55 in housing 137.

FIG. 4b shows a first state in which a coil 90 is unenergized and contact surface 5 is not displaced because its associated permanent magnet 70 has no electromagnetic force applied. Contact surface 5 is therefore disposed in a first position. In FIG. 4c, a current is induced in the coil 90, repelling magnet 70 and its associated sleeve surface inward. Each coil 90 is associated with a specific permanent magnet 70 and a specific local contact surface 5. Contact surface 5 is here drawn as a discrete unit, but it can also be embodied to be continuous with adjacent units as shown in FIGS. 5b and 5c.

The system as shown in FIG. 5a operates similarly to that shown in FIG. 4a, but in this example the force is applied to contact surface 5 by a displacement of a post 93 within coil 90, together forming solenoid 86. Solenoids 86 are restrained to an approximately orthogonal orientation by housing 137 and capped by pressure elements 46. Alternately solenoids 86 may be capped by weights 120, mimicking the structure shown in FIG. 1. Each solenoid 86 is held by a chamber 55 in housing 137. FIG. 5b shows a first state in which coil 90 is not energized and pressure elements 46 (or weight 120) has not yet displaced and contact surface 5 is disposed in a first position. Each set of post 93 and coil 90 is associated with a local contact surface 5. Contact surface 5 is drawn as a continuous unit, but it can also be embodied in discrete units as shown in FIGS. 3b, 3c, 4b and 4c. FIG. 5c shows a second state in which coil 90 is energized and contact surface 5 is displaced to a second position. The actively oscillated mass in this example would include the mass of the solenoid armature and the mass of any weight 120 or pressure element 46 capping the armature.

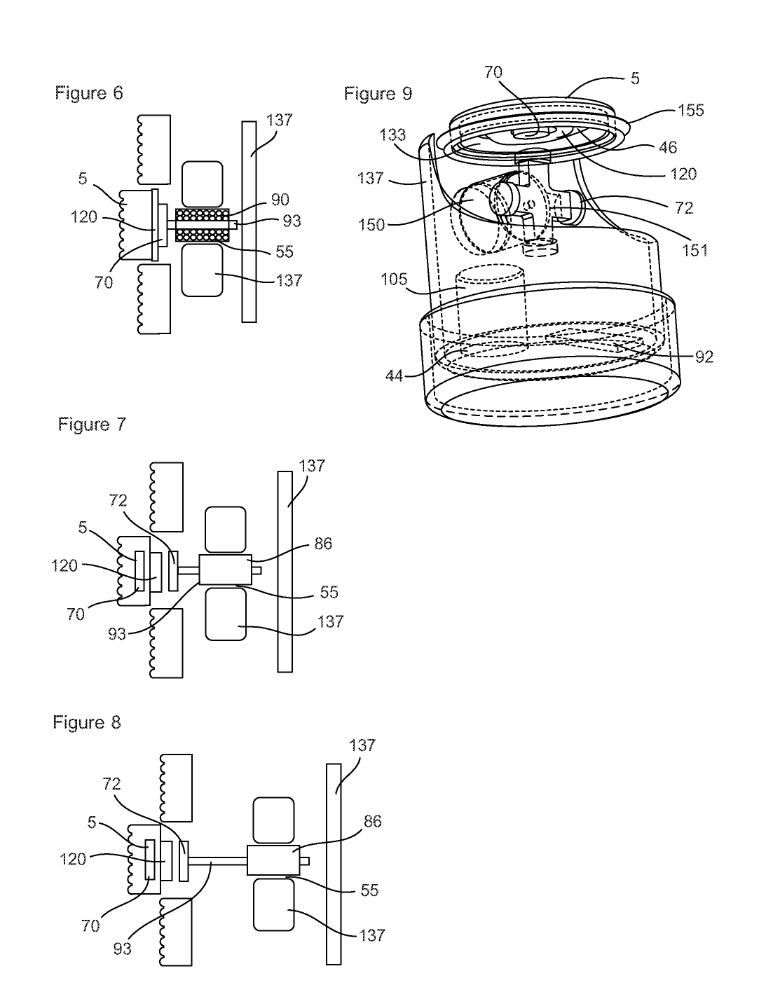

FIG. 6 shows an example in which features of FIGS. 4b and 5b are combined. The oscillating motion of contact surface 5 is provided by the electromagnetic field generated by coil 90 applying a force to magnet 70, which are both axially aligned with weight 120. The function of pressure element 46 may be integrally provided by weight 120 or may be an independent element. Post 93 may constrain the orthogonal relationship between magnet 70 and coil 90. In this example post 93 is made of a non-ferromagnetic material such as ABS because its only function is structural. In another example (not shown), post 93 is omitted and the orthogonal relationship between magnet 70 and coil 90 is maintained with a flexure such as provided by continuing a portion of contact surface 90 to meet the adjacent housing 137 as represented by the solenoid shown in the dashed circle of FIG. 5a. In flexure embodiments in which a higher durometer contact surface 5 is desired, the flexure may include an accordion fold around the perimeter of the contact surface 5.

FIG. 7 shows an example in which features of FIGS. 3b and 4b are combined. The oscillating motion of contact surface 5 is provided by driving magnet 72 actuated to travel a linear path closer and further to magnet 70. The two magnets are oriented to repel one another. Weight 120 moves with contact surface 5. Rod 93 is non-ferromagnetic and used only for maintaining the orientation of contact surface 5.

FIG. 8 shows an example in which features of FIGS. 3b and 5b are combined. The oscillating motion of contact surface 5 is provided by driving magnet 72 to travel in an oscillating linear path toward and away from magnet 70. The two magnets are oriented to repel one another. Weight 120 is disposed to move with contact surface 5. Rod 93 is ferromagnetic and used to displace driver magnet 72.

While these examples have all been described with respect to inducing motion and/or pressure variations at an inner sleeve surface, the systems and techniques described above, such as with respect to FIGS., 3a, 3b and 3c, may also be configured for phallic-shaped devices, such as by orienting the active elements outwards about a cylindrical housing. For example, the upper or lower half of FIG. 3a, 3b or 3c can be considered as half of the cross section of a dildo in which the mechanics are disposed within a sheath 11 rather than outside a sleeve 10, such that the contact surface 5 is disposed on an outwardly facing surface rather than an inwardly facing surface.

FIG. 9 shows a sexual stimulation device with a contact surface 5 that provides a range of linearly oscillating pressure sensations to the exposed skin of a sex organ. Contact surface 5 is made of a low durometer elastomer and affixed to the upper surface of a pressure element 46. The perimeter of contact surface 5 connects to housing 137 through a thin elastomeric flexure 155 preferably including an accordion fold allowing linear displacement relative to the housing along a line generally perpendicular to the contact surface. Flexure 155 provides a consistent linear restoration force around the circumference of contact surface 5. In one embodiment flexure 155 provides a nonlinear force profile, with a very low axial force when contact surface 5 is at its neutral location and the largest force as the pressure plate approaches the full extent of its travel, as defined by limit stop 133. Limit stop 133 is an extension of the internal part of housing 137 extending upwards toward the underside of pressure plate 46. It is contemplated that a spring, elastomer, or other such damper is disposed between the upper surface of limit stop 133 and the lower surface of pressure element 46. The approximate position of limit stop 133 is shown, but the stop itself is omitted for clarity.

Drive magnets 72 are mounted to magnet armature 151, which is mounted to the output shaft of rotary motor 150 such that at the top of the rotation drive magnet 72 will be located along the central axis of contact surface 5 and in close proximity with magnet 70, thereby displacing the contact surface outward, or inward, depending on the relative orientation of the two magnets. A linear embodiment of this actuation is provided in FIGS. 3a-3c. While four drive magnets 72 are shown, any number may be used. All drive magnets 72 may be oriented to repel magnet 70 (in such embodiments a spring 138 may be added to bias pressure plate 46 inward) or drive magnets 72 may be oriented such that adjacent magnets about armature 151 repel and attract, alternately, the magnet secured beneath the contact surface. Because no moving contact occurs between the armature and the underside of the pressure element, operation of the device may be nearly silent.

In the embodiment shown an additional weight 120 (or mass 276a) is added to pressure plate 46. Together with the spring force applied by flexure 155 the system will have a natural harmonic. The amplitude of travel of contact surface 5 can be increased or decreased by operating the motor at multiples of this harmonic, thereby providing more intense sensation to the user at these settings. It is contemplated that contact surface 5 may also be slidingly constrained (and restoring force provided) by mechanisms other rather than flexure 155 such as slides, bearings, and linkages. It is also contemplated for the device may have multiple contact surfaces 5 located on different sides of the device with a single motor 150 in which the contact surfaces 5 are different sizes or in which the weights 120 were different, thereby providing a greater range of sensations with the same device.

While several embodiments have been described, it will be apparent to one skilled in the art how the form, structure and arrangement of these embodiments may be varied (or combined with each other) and yet remain within the scope of the instant invention. The scope of the invention shall therefore be defined by the claims that follow.

What is claimed is:

1. A sexual stimulation device, comprising:
a housing;
an exposed sexual organ contact surface supported by the housing, the housing defining an elongated internal cavity having a longitudinal axis extending away from the contact surface;
a mass laterally constrained within and movable linearly along the cavity; and
an electrically driven actuator disposed within the housing and operable to accelerate the mass along the axis of the cavity, thereby oscillating the contact surface in a linear motion along the longitudinal axis.

2. The sexual stimulation device of claim 1, wherein the actuator includes a coil of wire axially aligned with the cavity.

3. The sexual stimulation device of claim 2, wherein the actuator comprises an electromechanical solenoid having an armature disposed within the coil of wire.

4. The sexual stimulation device of claim 3, wherein the armature is mechanically coupled to the contact surface.

5. The sexual stimulation device of claim 1, further comprising a magnet mechanically coupled to the contact surface.

6. The sexual stimulation device of claim 1, wherein the actuator comprises first and second magnets arranged such that repellant force between the first and second magnets applies a motive force to the contact surface.

7. The sexual stimulation device of claim 1, further including a magnet disposed within the cavity.

8. The sexual stimulation device of claim 7, wherein the magnet is operably coupled with the contact surface.

9. The sexual stimulation device of claim 1, wherein the contact surface is substantially flat.

10. The sexual stimulation device of claim 1, further including a controller coupled to the actuator and configured to control motion induced by the actuator.

11. The sexual stimulation device of claim 10, wherein the controller is configured to control motion of the contact surface according to a preset motion profile.

12. The sexual stimulation device of claim 11, wherein the motion profile includes a first acceleration rate in a first direction along the longitudinal axis, and a second acceleration rate in a second directions along the longitudinal axis, the second acceleration rate differing from the first acceleration rate.

13. The sexual stimulation device of claim 1, wherein the actuator is operable to produce a displacement of the contact surface of at least 10 mm along the longitudinal axis.

14. The sexual stimulation device of claim 13, wherein the actuator is operable to produce a displacement of the contact surface of at least 20 mm along the longitudinal axis.

15. The sexual stimulation device of claim 1, wherein the actuator is a linear motor.

16. The sexual stimulation device of claim 1, wherein the device is phallic-shaped.

17. The sexual stimulation device of claim 1, wherein the cavity is fully enclosed within the device.

18. A sexual stimulation device, comprising:
a housing;
an exposed sexual organ contact surface supported by the housing and adapted to contact a sexual organ of a human body while remaining outside the body; and
an electrically driven actuator disposed within the housing and operable to oscillate the contact surface in a linear motion in which the contact surface is displaced, with respect to the housing, along an axis perpendicular to the contact surface.

19. The sexual stimulation device of claim 18, further including a magnet mechanically coupled with the contact surface.

20. The sexual stimulation device of claim 18, further including a cylindrical non-ferromagnetic armature mechanically coupled with the contact surface and aligned with the axis.

21. The sexual stimulation device of claim 18, wherein the actuator includes a first magnet moved by operation of the actuator, the device further including a second magnet mechanically coupled with the contact surface, the first and second magnets configured and positioned such that motion of the first magnet induces a motion of the second magnet and the contact surface.

22. The sexual stimulation device of claim 21, wherein the first and second magnets are configured such that in their nearest positions similar poles of each magnet are facing one another, such that the first magnet repels the second magnet.

23. The sexual stimulation device of claim 21, wherein the first magnet is configured to be moved by operation of the actuator along a linear, reciprocating path.

24. The sexual stimulation device of claim 21, wherein the first magnet is configured to be moved by operation of the actuator along a circular path.

25. The sexual stimulation device of claim 21, wherein the actuator includes multiple magnets spaced about a perimeter of an armature, such that rotation of the armature brings each of the multiple magnets in succession into proximity with the second magnet.

26. The sexual stimulation device of claim 25, wherein adjacent ones of the multiple magnets are of opposite polarity arrangement, such that rotation of the armature alternately repels and attracts the second magnet.

27. The sexual stimulation device of claim 18, further comprising a spring coupling the contact surface and housing, and wherein the actuator is configured to oscillate the contact surface at a frequency selected to correspond with the natural frequency of the contact surface in association with the spring.

28. The sexual stimulation device of claim 18, wherein the housing defines an elongated internal cavity having a longitudinal axis substantially perpendicular to the contact surface.

29. The sexual stimulation device of claim 28, wherein the actuator comprises a coil of wire disposed around the cavity.

30. The sexual stimulation device of claim 29, wherein the actuator comprises an electromechanical solenoid having an armature disposed within the coil of wire.

31. The sexual stimulation device of claim 30, wherein the armature is mechanically coupled to the contact surface.

32. The sexual stimulation device of claim 28, further including a magnet mechanically coupled with the contact surface.

33. The sexual stimulation device of claim 18, wherein the contact surface comprises an exposed elastomeric material positioned to contact the sexual organ.

34. The sexual stimulation device of claim 18, wherein the contact surface is generally cylindrical and configured to fit about a male sexual organ.

35. The sexual stimulation device of claim 18, wherein the contact surface is substantially flat.

36. The sexual stimulation device of claim 18, further including a controller coupled to the actuator and configured to control motion induced by the actuator.

37. The sexual stimulation device of claim 36, wherein the controller is configured to control motion of the contact surface according to a preset motion profile.

38. The sexual stimulation device of claim 37, wherein the motion profile includes a first acceleration rate in a first direction along the perpendicular axis, and a second acceleration rate in a second directions along the perpendicular axis, the second acceleration rate differing from the first acceleration rate.

39. The sexual stimulation device of claim 18, wherein the actuator is operable to produce a displacement of the contact surface of at least 10 mm along the perpendicular axis.

40. The sexual stimulation device of claim 39, wherein the actuator is operable to produce a displacement of the contact surface of at least 20 mm along the perpendicular axis.

41. The sexual stimulation device of claim 18, wherein the actuator is a linear motor.

42. A method of creating sexual stimulation, the method comprising
bringing the contact surface of the device of claim 1 into contact with a sexual organ; and
holding the device with the contact surface in contact with the sexual organ while the actuator is operated to oscillate the contact surface in a primarily linear motion along the longitudinal axis.
